(19) United States
(12) Patent Application Publication
(10) Pub. No.: US 2009/0185865 A1
(43) Pub. Date: Jul. 23, 2009

(54) SOFT EXCAVATION POTHOLING METHOD AND APPARATUS

(75) Inventors: Richard F. Sharp, Perry, OK (US); Kelvin P. Self, Stillwater, OK (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(73) Assignee: The Charles Machine Works, Inc., Perry, OK (US)

(21) Appl. No.: 11/560,764

(22) Filed: Nov. 16, 2006

Related U.S. Application Data
(60) Provisional application No. 60/737,837, filed on Nov. 16, 2005.

(51) Int. Cl. F16L 55/00

(52) U.S. Cl. 405/157

(57) ABSTRACT

A method and apparatus for locating an underground object. The apparatus comprises an excavation head, a wave emitter, a receiver, and a processor. The excavation head is adapted for soft excavation of soil. The excavation head may use mechanical means to dislodge soil, pressurized air or water, or a combination of methods. The wave emitter, located proximate the excavation head, transmits waves into the soil. The receiver receives waves reflected by underground objects. Information about the reflected waves is processed by the processor to determine the location of the underground object.

### CROSS REFERENCE TO RELATED APPLICATIONS

This application claims priority of U.S. Provisional Patent Application No. 60/737,837, filed Nov. 16, 2005, the contents of which are incorporated fully herein by reference.

### FIELD OF THE INVENTION

The present invention relates to systems for soft excavation, particularly to systems used to expose existing underground utilities to verify their location—a process known as “potholing” or “daylighting”.

### SUMMARY OF THE INVENTION

One aspect of present invention is directed to a method for exposing an underground object. The method comprises excavating soil, transmitting an electromagnetic wave into the earth, receiving reflected electromagnetic waves, and processing at least one property of the reflected waves. The soil is excavated using a soft excavation device in an area of the underground object. The electromagnetic wave is transmitted from the soft excavation device. The reflected electromagnetic waves are received from the underground object. The property of the reflected waves is processed to determine a location of the underground object relative to the soft excavation device.

In another aspect, the present invention is directed to an apparatus comprising an excavation head, a wave emitter, a receiver, and a processor. The excavation head is adapted for soft excavation of soil. The wave emitter is located proximate the excavation head and is adapted to transmit electromagnetic waves. The receiver is adapted to receive waves reflected by at least one underground object. The processor is adapted to process a property of the received waves to determine a location of the underground object.

### BRIEF DESCRIPTION OF THE DRAWINGS

FIG. 1 is a partial cutaway side view of the soft excavation system of the present invention.

FIG. 2 is a frontal view of a radar antenna set suitable for use with the present invention.

FIG. 3 is a frontal view of an excavation head for use with the present invention.

FIG. 4 is a frontal view of an alternative excavation head for use with the present invention.

FIG. 5 is a frontal view of another alternative excavation head for use with the present invention.

FIG. 6 is a cutaway partial side view of an alternate embodiment of the present invention.

### DETAILED DESCRIPTION OF THE DRAWINGS

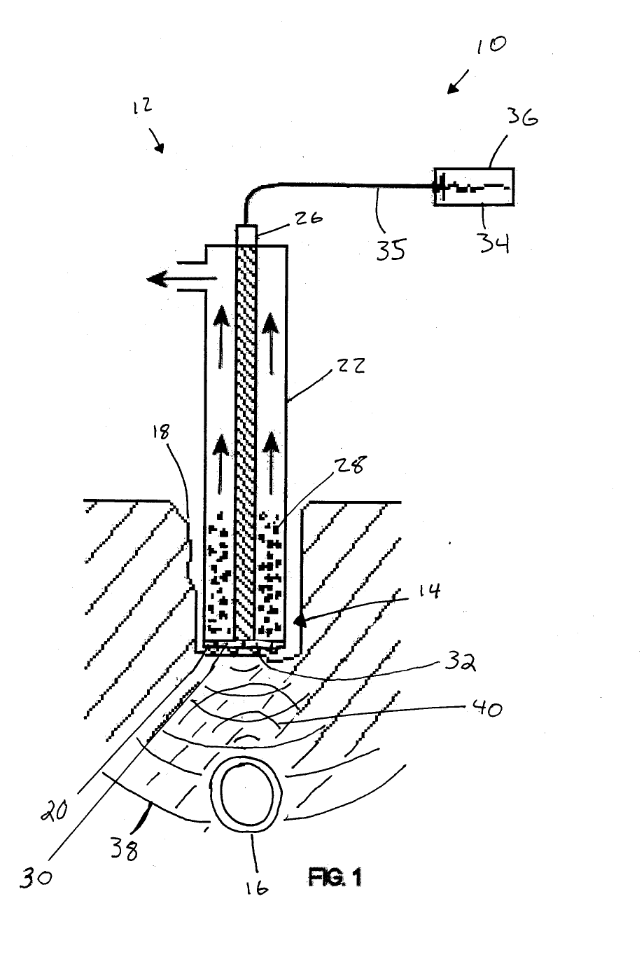

Turning to FIG. 1, shown therein is a novel excavation detection system 10. The system 10 comprises a soft excavation unit 12 and a radar system 14. The system 10 is useful for detecting objects 16 in the vicinity of the advancing excavation unit 12. The system 10 is particularly suited for exposing existing underground utilities or other underground objects via one or more small diameter excavations 18. This process of visually verifying the precise location of the utilities or other objects is known as “potholing” or “daylighting”. This process is usually preceded by the marking of approximate paths of underground utilities via electromagnetic cable locators or similar devices employed by the owners of this existing buried plant, or by a One Call service. Sometimes such markings alone are sufficient to minimize the potential for planned construction activity to damage existing underground utilities. However, it is often necessary to more precisely determine the location and depth of these utilities at selected points along their paths. That is particularly the case when planned excavations encroach upon or cross the marked pathways. Daylighting of a particular existing pipe or cable 16 is also useful to obtain access for localized repair, or to connect a new branch off the existing service.

One skilled in the art can appreciate that marking of underground utilities via electromagnetic cable locators may be subject to operator error or influence of local surroundings (above and below ground). Also, some pipes and cables are nonmetallic (plastic pipe, fiber optic cable) and may have been buried without the addition of a tracer wire or other locating aid. Because of these realities, daylighting an existing pipe or cable 16 can often be a trial and error process where an increasingly larger hole 18 is excavated or several randomly positioned holes are made before the utility is encountered. This becomes a time consuming activity, often more subject to luck than to skill of the operator. Current soft excavation techniques compound this productivity problem because they cannot be overly aggressive while dislodging the soil overburden, otherwise damage may occur when the buried utility or object 16 is eventually encountered. As will become clear, the present invention overcomes large portions of these two shortcomings.

With reference still to FIG. 1, the soft excavation unit 12 comprises an excavation head 20, an outer housing 22, and a spoil discharge outlet 24. Preferably, the unit 12 further comprises a shaft 26. More preferably, the shaft 26 lies on a centerline of the unit 12. The excavation head 20 is operatively connected to the center shaft 26. The outer housing 22 bearingly supports the hollow center shaft 26. The excavation head 20 may be attached to the distal end of the shaft 26 such that rotation of the shaft causes like rotation of the head 20. Alternately, the excavation head 20 may be of two or more parts, wherein the outer portions thereof attach to the lower end of the outer housing 22. One skilled in the art can readily devise a drive system to rotate (or oscillate) the shaft 26 relative to the outer housing 22. Provision may also be made to retract all or portions of the excavation head 20 within the lower confines of the outer housing 22. In an alternative embodiment, the shaft 26 may be used to carry high pressure fluid.

The excavation head 20 comprises a means for dislodging soil. Preferably, the excavation head 20 comprises mechanical cutters. Alternatively, the excavation head 20 utilizes pressurized air and/or water. More preferably, the head 20 comprises both cutters and air and/or water to dislodge soil. Representative air or water systems are disclosed in commonly assigned U.S. Pat. Nos. 5,212,891 and 5,361,855, incorporated herein by their reference. In the '855 patent, upward directed jets create suction through a venturi effect to evacuate the dislodged soil, or spoil 28.

The spoil 28 is removed from near the head 20 by a vacuum system (not shown). The spoil 28 is transported up the excavation 18 inside the hollow outer housing 22 to the spoil discharge outlet 24. Preferably, a vacuum system suction hose (not shown) would connect to the spoil discharge outlet 24. In the typical situation where the location of the existing utility 16 is only vaguely known, the soft excavation process must generally be employed for the full depth of the excavation 18.

With reference still to FIG. 1, the exact nature of the excavation unit 12 is not limiting upon the present invention. The device 12 could be an adaptation of existing soft excavation technology. Preferably, one or more aggressive excavation technologies will be incorporated in a manner to be available for selective use. For illustrative purposes, the excavation unit 12 is shown to comprise the tubular outer housing 22, which may or may not be rotatable about its longitudinal axis. In the present example, the housing 22 does not revolve, but may be oscillated clockwise-counterclockwise a fraction of a revolution about its axis. Alternatively, the rotary spoil discharge outlet 24 could be adapted to allow more than partial revolution.

With continued reference to FIG. 1, the excavation detection system 10 comprises the radar system 14 suitable for detecting and classifying nearby buried utilities or other objects 16. The detection system 14 may comprise more than one type, or alternative types, of utility locating/detecting technology.

In a preferred embodiment, the detection system 14 comprises a ground penetrating radar system. The GPR of the detection system 14 comprises a transmitting antenna 30 and a receiving antenna 32. The antennas 30, 32 preferably are operatively connected to an electronics module 34. Preferably, the electronics module 34 comprises a display 36 for displaying information to an operator. As shown in FIG. 1, the electronics module 34 is located external to the housing 22. In the embodiment of FIG. 1, the antennas 30, 32 are connected to the module 34 by a cable 35. Power may be supplied to the electronics module 34 via a battery pack or alternately through a wire routed down the center shaft 26. Alternatively, the electronics module 34 may be housed inside the hollow outer housing 22 or at any other suitable location. One skilled in the art can appreciate that cabled connections might require the use of slip ring contacts where the respective mounting locations of the radar components experience relative rotary motion. Alternately, radio frequency transmission of data may be utilized to cross such boundaries.

Continuing with FIG. 1, the transmitting antenna 32 of the radar system 14 transmits time-spaced pulses of electromagnetic energy. The transmitting antenna 32, or wave emitter, is preferably generally downwardly-directed, forming a series of transmitted electromagnetic waves 38 that travel into the earth. The waves 38 travel ahead of the downwardly advancing excavation head 20. When one of the transmitted waves 38 encounters a change (discontinuity) in the dielectric constant and/or the electrical conductivity of the soil—such as may be caused by the presence of a buried pipe 16 or other object—a portion of its energy is reflected back toward the excavation head 20. Reflected waves 40 are received by the receiving antenna 32. The receiving antenna 32 communicates data signals representative of the received waves 40 to the electronics module 34. The signals received by the module 34 are processed by the module to determine a relative position and distance to the object 16. Information about the position and distance to the object 16 is then shown on the display 36.

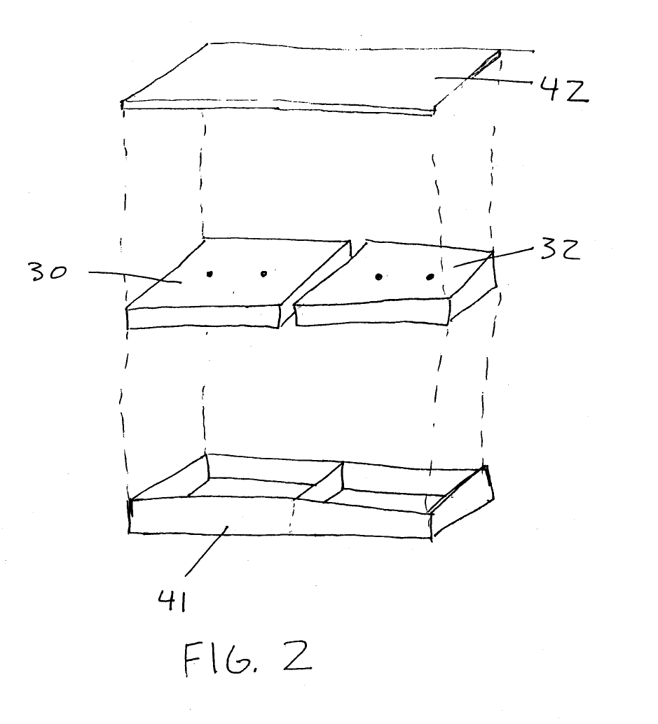

Turning now to FIG. 2, shown therein is a preferred embodiment for a mounting 41 of the transmitting antenna 30 and the receiving antenna 32. In any configuration, mounting of the antennas 30, 32 requires that no metallic material obscures the antennas nor their approximately 150° aperture. As shown in FIG. 2, the mounting 41 further comprises a protective plate 42. The plate 42 provides protection from abrasion for the antennas 30, 32. Preferably, the plate 42 is made of electromagnetically transparent material, so as not to disrupt the transmission of the emitted waves 38 nor the receipt of the reflected waves 40. More preferably, the plate 42 will be made of a ceramic material. Most preferably, the plate 42 will have a dielectric constant approximating that of the surrounding soil. Other similar material such as plastics may be suitable for transmission of the waves 38. The plate 42 must be capable of withstanding abrasive forces associated with excavation.

To further prevent interference with antenna transmission and reception, other portions of the excavation head 20 and the lower extends of the outer housing 22 may also be constructed of such material. This allows the antennas 30, 32 to be alternatively mounted in an outwardly canted orientation. A close encounter with an object 16 may then be detected even though the excavation 18 would not have intersected it upon first attempt. Once detected, the object 16 can then be daylighted by over-sizing or re-directing the excavation 18 toward its position.

The reflected radar signals 40 may also allow a preliminary characterization of the identity of the object. For example, a linearly aligned series of returns may be indicative of a pipe or cable, while localized returns may represent a stone or similar object. Depending on the characterization of the object 16, the excavation process can be appropriately altered or stopped. For example, having obtained information about the object, a more aggressive excavation process can be utilized until the object 16 is neared. Preferably, when the excavation head 20 is close to the object 16, aggressive excavation may be stopped and the object may be exposed with soft excavation.

When radar returns are absent, the aggressive excavation process can be utilized to bring the radar antennas 30, 32 within range of the suspected location of the object 16. This is a particularly useful approach where soil conditions limit the range of the radar system 14. A similar situation may occur when a small diameter buried utility 16 is being sought. The lower end of the frequency spectrum transmitted by the pulse radar system 14 may not reflect off such objects 16, whereas higher-end frequencies are more quickly attenuated in soil. Thus the excavation 18 will likely have to advance closer to a small diameter buried utility 16 before it is detected.

The location of the object 16 is initially determined relative to that of the receiving antenna 32. The downward progress of the excavation head can be stopped—or, more preferably, its aggressive excavation process can be softened—prior to contacting the object 16. The radar system 14 may also include one or more linear displacement and angular orientation sensors on the excavation unit 12. Each radar “return” may be individually “tagged” with the respective rotational or linear orientation of the excavation head 20 at the time the associated transmitted wave 38 was emitted. The relative location of the object may then be converted (by transformation of coordinates) to depth below the ground surface along with any directional offset identified. Alternatively, the location of the object 16 may be expressed as radial distance and angular direction in polar coordinates from the centerline of the excavation 18. The operator may then be provided the location of the object 16 to know in which direction to direct the excavation 18. Following location confirmation of the object 16 with the smallest opening practical, the excavation 18 can be enlarged with the excavation device 12 to accommodate desired access.

The radar system 14 illustrated herein is capable of “seeing” about twenty inches beyond the excavation head 20 in “typical” soils and about twenty-eight inches in ideal conditions. Here, the distance the radar can “see” means the practical range at which sufficiently strong reflected waves will be returned from an object 16 to be detected by the receiving antenna 32. Automated shut-down of aggressive downward progress of the excavation head 20 or initiation of an alarm may be instigated whenever a suspicious reflection is detected by the radar system 14. One skilled in the art can readily implement such control features with the aid of principles disclosed in commonly assigned U.S. Patent Application Publication No. 2004/0028476 “System and Method for Automatically Drilling and Backreaming a Horizontal Bore Underground” and in U.S. Pat. No. 6,550,547 by Payne, et al., the contents of which are incorporated herein by their reference.

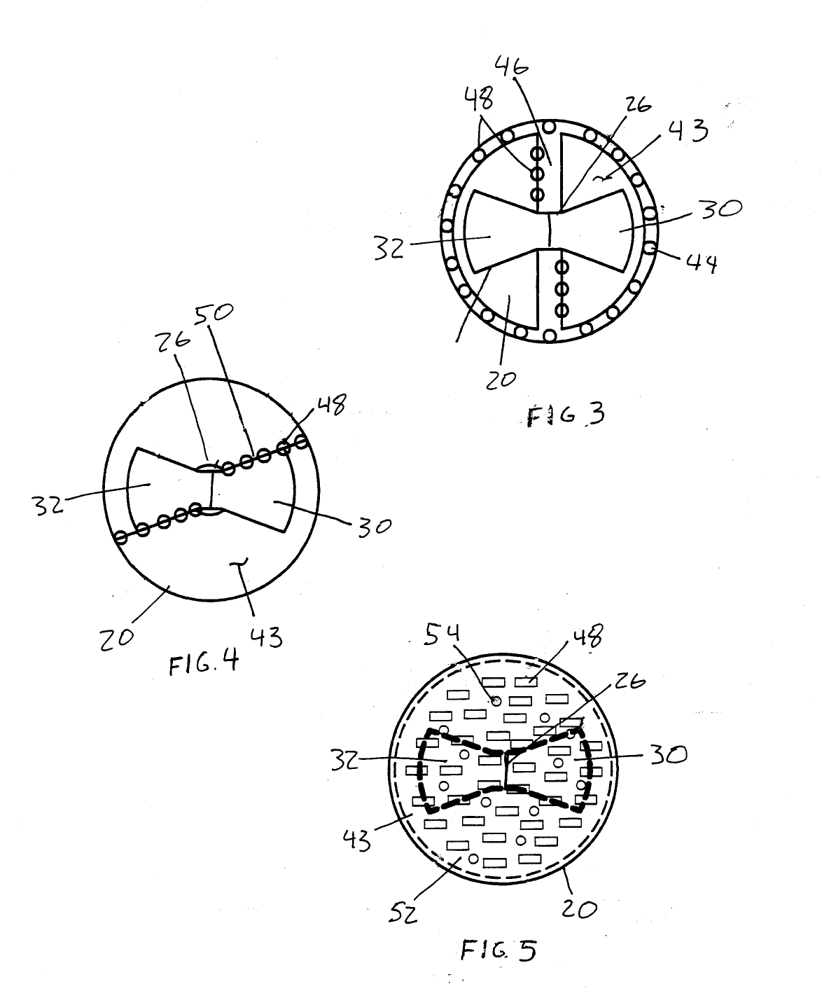

With reference now to FIGS. 3-5, shown therein are placements of the antennas 30, 32 relative to alternative cutting structures for the excavation head 20. For each of the cutting structures shown, spoil is removed from the vicinity of the excavation head 20 via entry into the outer housing 22 through spoil inlets 43.

FIG. 3 shows one type of soil cutting structure wherein the excavation head 20 comprises a shell 44, a cutting bar 46, and cutting teeth 48. The center shaft 26 (FIG. 1) is rotationally attached to the shell 44. When the shell 44 is caused to rotate, it works together with cutting bar 46 and teeth 48 to dislodge the soil. The teeth 48 are preferably placed proximate first and second opposite sides of the antennas 30, 32. In this way, the antennas 30, 32 are oriented such that the operation of the teeth 48 and cutting bar 46 do not interfere with transmission of the waves 38. Preferably, the antennas 30, 32 rotate with the cutting bar 46.

FIG. 4 shows an alternative mechanical cutting structure for the excavation head 20 and antenna 30, 32 placement. In this embodiment, the excavation head 20 comprises the cutting teeth 48, and a partial auger 50. The auger 50 is rotated by the center shaft 26 to dislodge soil in conjunction with the cutting teeth 48 disposed at the edges of the auger. The antennas 30, 32 are preferably centrally located and oriented such that the operation of the teeth 48 and auger 50 do not interfere with transmission of the waves 38.

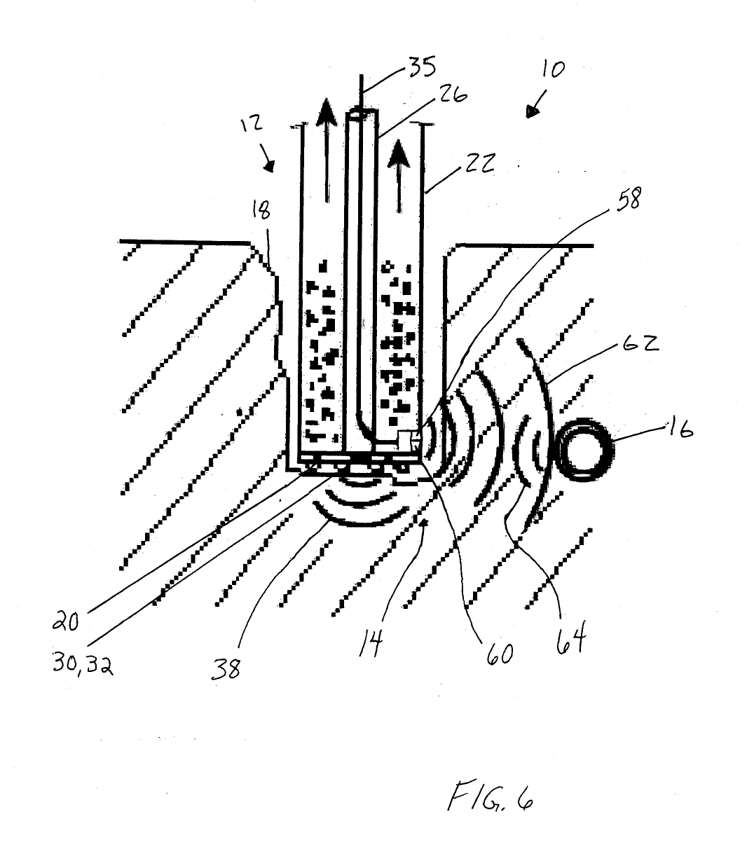

FIG. 5 shows yet another alternative excavation head 20. In this embodiment, the head 20 comprises a moving disk 52, the cutting teeth 48, and discharge holes 54. The disk 52 may rotate or move in a fashion to dislodge soil. Preferably, the disk oscillates to dislodge the soil but not damage any object 16. The discharge holes 54 are adapted to allow discharge of fluid, such as air, water, or a combination thereof, for dislodging soil. In some situations, only pressurized fluid may be used to dislodge the soil. The antennas 30, 32 are preferably located beneath the moving disk 52, which protects the antennas from abrasion during the excavation process. More preferably, the disk 52 is made of an electromagnetically transparent material such as that described above.

One can anticipate many other types of excavation head 20. Various water jet/nozzle configurations could be applied. Step changes or gradual variation in input (drive) horsepower, fluid pressure, or extension/retraction of soil-cutting teeth may be utilized. A prime feature of the present invention is that the degree of soil dislodgement aggressiveness is changeable—being diminishable to the level of soft excavation techniques when exposing the buried utility 16 in the last increments of creating the pothole 18.

Turning now to FIG. 6, an alternative embodiment of the radar system 14 is shown. The system 14 is further comprised of a transmitting antenna 58 and a receiving antenna 60. The antennas 58, 60 are mounted in or along a side of the housing 22. Mounting in this manner allows the antennas 58, 60 to be oriented in an approximately radially outward direction from the center shaft 26. As illustrated in FIG. 6, transmitted waves 62 from the antenna 58, or wave emitter, are transmitted from the side of the unit 12. Also, as shown, corresponding reflected waves 64 off a pipe or other object 16 located adjacent the unit 12 may be received by the receiving antenna 60.

The antennas 58, 60 are preferably closely positioned adjacent an interior wall of the outer housing 22 that may be cylindrical in nature. Consequentially, the spatial relationship or shape of the antennas 58, 60 may differ from the antennas 30, 32. Preferably, the antennas 58, 60 may be separated from one another or may be constructed in a curvilinear profile conforming to an inside diameter of the housing 22. Preferably, one or more ceramic cover plates, such as the plate 42 discussed in FIG. 2, protect the antennas from contact with the outer housing 22.

The transmitting and receiving antennas 58, 60 are positioned adjacent to the sidewall and face of the excavation 18 and are preferably mounted to provide a sweep in all radial directions around the centerline of the excavation 18 being created. Mounting the antennas on a rotating excavation head 20 would accomplish this goal. The antennas or sets of antennas could be mounted at any intermediate angle (such as 45°) to provide desired coverage around the area being excavated. Additional antenna sets could be utilized to provide total periphery sight. These antennas could be selectively turned on or off or used intermittently by a control system.

The system 10 can detect buried objects 16 lying within the sideward-looking radar's detection radius surrounding the pothole 18 being excavated. Having obtained this information, the operator may choose to abandon the present excavation 18, re-position the excavation head 20 overhead of the detected object 16, and proceed to uncover it.

Utilizing a lower center frequency for the sideward-looking radar's transmitted pulse of electromagnetic energy can extend its detection range beyond the twenty-inch range of the downward-looking radar 14 previously described. However, as is well-known, the reduction in center frequency cannot be overly large because of the negative effect on resolving (detecting) small objects. One versed in the design of GPR systems for location of utility services is readily able to weigh these trade-offs and implement a suitable sideward-looking system.

The present invention provides opportunity to reduce the amount of trial and error excavation presently involved in daylighting underground utilities and other objects 16. Productivity of utility verification is increased and the volume of spoil 28 excavated is reduced by zeroing in on the location.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that the invention may be practiced otherwise than as specifically illustrated and described.

1. A method for exposing an underground object comprising:
excavating soil using a soft excavation device in an area of the underground object;
transmitting an electromagnetic wave into the earth from the soft excavation device;
receiving electromagnetic waves reflected from the underground object;
processing at least one property of the reflected waves to determine a location of the underground object relative to the soft excavation device;
directing the soft excavation device to the underground object; and excavating soil using the soft excavating device proximate the determined location;
wherein the determined location of the underground object comprises a distance and a direction to the object from the excavation head.

2. The method of claim 1 wherein the wave is transmitted from a bottom surface of the soft excavation device.

3. The method of claim 1 wherein the wave is transmitted from a radial surface of the soft excavation device.

4. The method of claim 1 further comprising transmitting information to a processor.

5. The method of claim 4 wherein the information is transmitted wirelessly.

6. (canceled)

7. The method of claim 1 further comprising adjusting a rate of the excavation of soil in response to the determined location of the object.

8. The method of claim 1 wherein the electromagnetic waves comprise ground piercing radar waves.

9. An excavation apparatus comprising:
an excavation head adapted for soft excavation of soil;
a wave emitter, located proximate the excavation head, adapted to transmit electromagnetic waves:
a receiver, adapted to receive waves reflected by at least one underground object; and
a processor, adapted to process a property of the received waves to determine a location of the underground object relative to the excavation head and to direct the excavation apparatus to the location of the underground object, the location of the underground object comprising a distance and a direction to the object from the excavation head.

10. The apparatus of claim 9 wherein the excavation head utilizes water to excavate soil.

11. The apparatus of claim 9 wherein the excavation head utilizes pressurized air to excavate soil.

12. The apparatus of claim 9 wherein the excavation head comprises mechanical cutters to excavate soil.

13. The apparatus of claim 9 wherein the receiver is located proximate the wave emitter and wherein the wave emitter transmits waves along an expected path of advancement of the excavation head.

14. The apparatus of claim 9 further comprising a vacuum system adapted to remove dislodged soil from proximate the excavation head.

15. The apparatus of claim 9 comprising multiple emitters and receivers.

16. The apparatus of claim 15 wherein at least one of the emitters or receivers is downward-facing.

17. The apparatus of claim 9 wherein the wave emitter is downward facing.

18. The apparatus of claim 9 wherein the wave emitter is radially facing.

19. The apparatus of claim 9 wherein the wave emitter emits ground piercing radar.

20. The apparatus of claim 1 wherein the electromagnetic wave is transmitted along an expected path of advancement of the soft excavation device.
